(19) United States
(12) Patent Application Publication
(10) Pub. No.: US 2012/0011239 A1
(43) Pub. Date: Jan. 12, 2012

(54) METHODS AND APPARATUS FOR AUTOMATED WORKFLOW MANAGEMENT

(75) Inventors: Mikkel A. Svane, San Francisco, CA (US); Morten Primdahl, San Francisco, CA (US); Alex Aghassipour, San Francisco, CA (US); Maksim Ovsyannikov, San Francisco, CA (US)

(73) Assignee: ZenDesk, Inc., San Francisco, CA (US)

(21) Appl. No.: 13/181,218

(22) Filed: Jul. 12, 2011

Related U.S. Application Data
(60) Provisional application No. 61/363,604, filed on Jul. 12, 2010.

(51) Int. Cl. G06F 15/173

(52) U.S. Cl. 709/223

(57) ABSTRACT

Methods and apparatus for automated management of workflow that allows for the automatic creation, organization, and updating of workflows upon the receipt or designation of one or more messages.

### CROSS-REFERENCE TO RELATED APPLICATION

This application claims priority to and the benefit of, and incorporates herein by reference in its entirety, U.S. Provisional Patent Application No. 61/363,604, which was filed on Jul. 12, 2010.

### FIELD OF THE INVENTION

The present invention relates generally to methods and apparatus for automated management of workflow, and in particular to the automatic creation, organization, updating, and editing of workflow upon the receipt or designation of one or more messages.

### BACKGROUND OF THE INVENTION

The volume of information that modern businesses and organizations receive, manage, and generate often grows substantially as they expand and evolve, making it tremendously difficult to manage and organize that information. When combining this volume of information with the plethora of complex projects that often exist in these organizations, the challenge of managing the information may become insurmountable. Many workflow management systems have been developed to help organize the information of these entities, often by creating workflows, breaking projects down into steps or tasks. Items of information are then associated with a particular workflow, each of which may be further associated with workflow items such as tasks or subtasks.

While these tools may help entities access information related to a particular project or a particular task, they first require these workflows to be created and manually defined. Moreover, these tools typically require a human to review any newly added information and determine its relation to a particular project and task, out of the possibly thousands of different projects and millions of tasks. In addition, many of these tools operate with an entity's own information, despite the fact that items of information associated with a particular workflow often reside outside the organization. Thus, in attempting to solve one problem, these workflow tools can create many other challenges for businesses and organizations, including inaccuracy, delay and information fragmentation.

Accordingly, there is a need for improved methods and apparatus for automated workflow management that allows for the automatic creation, assignment, organization, and updating of workflows.

### SUMMARY OF THE INVENTION

Embodiments of the present invention provide methods and apparatus for automated workflow management. Exemplary embodiments of the present invention allow workflows to be automatically created upon the receipt of items of information. Upon the receipt of additional items of information, the associated workflow is automatically identified and updated. The workflows are further automatically organized and updated.

In one aspect, embodiments of the present invention provide a method for the automated management of a workflow and include the steps of designating a message from a plurality of messages and then automatically initiating a workflow in response to the designating of the message.

In one embodiment, the step of designating a message includes designating the text message as a favorite using a publicly available Application Programming Interface, or API. In certain embodiments, the method further includes utilizing the contents of the designated message as an input to the workflow. Other embodiments include a step of receiving a message within the workflow and posting it to the plurality of messages. In one embodiment, the method further includes the steps of receiving a message related to the initiated workflow and adding the received message to the workflow in response to the receiving of the message.

In particular embodiments, the workflow is a support ticket. A support ticket, for example, may include information describing a user's request or a problem that a support team may be able to resolve with its expertise.

In one alternative embodiment, the method further includes the step of importing social profile information into the workflow. It may be possible to further specify conditional actions that occur or are triggered by the importing of the social profile information into the workflow. In yet another embodiment, the method further includes the step of performing conditional actions that are triggered by a predetermined event. In some embodiments, the method further includes the step of managing the workflow in an account associated with the plurality of messages.

In another aspect, embodiments of the present invention provide a device for the automated management of a workflow comprising a processor and a memory coupled to the processor. In these embodiments, the memory includes program instructions that, when executed by the processor result in the designation of a message from a plurality of messages. The memory also includes program instructions that, when executed by the processor, result in the initiation of a workflow in response to the designating of a message.

In certain embodiments, the program instructions to designate a message include program instructions that designate the message as a favorite using a publicly available API. The memory may further include program instructions that when executed by the processor result in the programmatic usage of the contents of the designated message as input to the workflow. Alternatively, the memory may include program instructions in the memory that, when executed by the processor, result in the programmatic receipt of a message within the workflow and posting that received message to the plurality of messages.

In several embodiments, the memory includes program instructions that, when executed by the processor, result in the programmatic receipt of a message related to the initiated workflow. In these embodiments, the program instructions may also cause the adding of the received message to the workflow in response to the receipt of the message.

In addition, some embodiments include program instructions in the memory of the device that, when executed, result in the programmatic import of social profile information into the workflow. One embodiment further contains program instructions in the memory that result in the programmatic specification of conditional actions that are triggered by the imported social profile information.

In at least one embodiment, the memory further includes program instructions that, when executed, result in the programmatic performance of conditional actions triggered by a predetermined event. In yet another embodiment of the disclosed device, the device's memory contains program instructions that, when executed by the processor, result in the programmatic management of the workflow with an account associated with the plurality of messages.

The foregoing and other features and advantages of the present invention will be made more apparent from the description, drawings, and claims that follow.

### BRIEF DESCRIPTION OF DRAWINGS

The present invention will now be described, by way of example only, with reference to the accompanying Figures, in which:

FIG. 1 depicts an exemplary method of automating the management of workflow in accord with the present invention;

FIG. 2 illustrates an interconnected network of Automated Management Servers, Client Devices, and Information Sharing Servers in accord with one embodiment of the present invention;

FIG. 3 depicts the automated management of workflows by an Automated Management Server in accord with the principles of the invention;

FIG. 4 presents an example of an Automated Management Server and an Information Sharing Server, connected via an application programming interface, in accord with one embodiment of the present invention; and

FIG. 5 depicts automated workflow creation utilizing messages communicated among Client Devices and the Automated Management Server in accord with one embodiment of the present invention.

The following describes in detail various embodiments of the present invention that provide automated workflow management. One of ordinary skill in the art would understand that standard programming and engineering techniques may be used to produce such embodiments including software, firmware, hardware, or any combination thereof to implement the disclosed subject matter. The attached Figures depict exemplary embodiments and are meant to be understood in view of the details disclosed herein.

### DETAILED DESCRIPTION OF THE INVENTION

Generally speaking, workflow management systems organize the ever-growing volume of information that modern businesses and organizations receive, manage and generate by separating a project into a series of tasks. The completion of every task in a project results in the completion of the workflow. Workflow management systems may also allow files and messages to be associated with a particular workflow.

Responsibility for completing each stage in the workflow may be assigned, thereby allowing completion of tasks by different individuals or groups. Once a task is complete, the workflow software may notify the next user or group as to their required task. Upon the completion of the workflow, the project manager may be automatically notified. Thus, different workflows may be created for different projects and information may be associated with each workflow or more specifically, with each task, as deemed necessary.

Workflow management systems are often used in the Information Technology (“IT”) field, where projects to manage and secure technology and data in an organization are often complex or large in volume and frequently require the coordinated efforts of many employees. The term IT is used broadly here and may include the development, troubleshooting, or distribution of technology in any manner. An IT department often creates hundreds of projects daily (called “support tickets” in the industry) to track and resolve technical issues experienced by its clients, including hardware malfunction, software installation, etc.

Exemplary short term and long term IT projects created in the system can include securing or improving the hardware, software and networking capabilities of the organization and its products. These projects often include a number of steps. For example, a project to fix a software issue on a particular computer often involves a multitude of necessary steps, including: initiating contact with the user of the computer, arranging a meeting, meeting with the user and fixing the software as necessary, and receiving user feedback. The first two steps may be completed by a help-line staffer, the third and fourth tasks may be completed by a trained IT professional, and the last task may be completed by, e.g., an e-mail based survey system. The use of workflows allows these steps to be created and assigned as tasks within the workflow. The creation of the tasks and workflow also allows orderly communications between the client and the help desk and the association of other information with the workflow, such as the software to be installed may also be associated with the workflow.

As another example, in another setting such as manufacturing, a design document for a project might be routed from designer to a technical designer and then finally to a production manager. Workflow management systems ensure that the project is completed in a timely and orderly fashion, in this case, by notifying the person responsible for a task upon the completion of the preceding task. It further ensures that all information associated with particular tasks or projects can be tracked and easily accessible. In this example, each version of the design document may be associated with the workflow as each task in the workflow is completed.

The examples described above are used throughout the detailed description of the invention to describe and demonstrate the use of the automated workflow management methods and apparatus in a real world application. However, its use is not meant to limit to the scope of the subject matter disclosed and claimed herein. The automated workflow management methods and system may likewise be applied in manufacturing, technology development, industrial development and design, administration, general business development, customer service, and other industries.

### Automated Workflow Initiation and Management

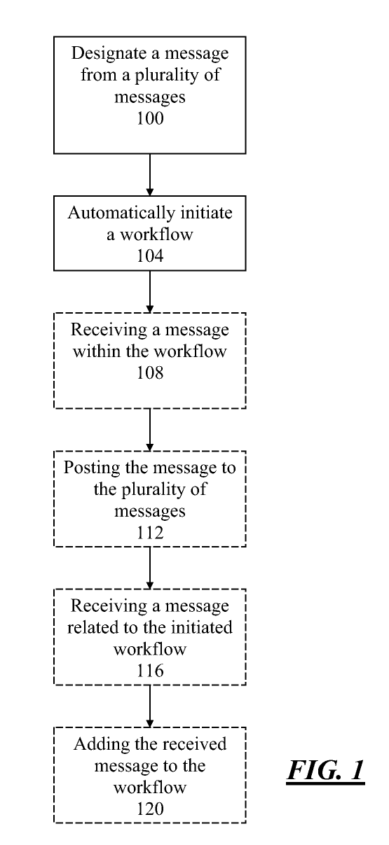

Embodiments of the present invention improve upon current workflow management systems by allowing for the automatic creation, deletion, editing, and overall management of workflows. Referring now to FIG. 1, a flowchart of one embodiment of a method for automated workflow management is provided. In this method, a message is designated from a plurality of messages (step 100). A message may contain text, pictures, video, audio or any combination thereof. The message may even be a digital file or parts thereof, in any format, containing information or data. The message may be directed to a certain topic or directed to a certain user profile that is associated with the workflow management system (“Associated Profile”). As such, embodiments of the invention encompass message lists that specifically relate to a particular topic or a particular user profile. In one exemplary embodiment, messages may also be sent privately to a particular Associated Profile.

The plurality of messages in the list may be, for example, a mailbox containing a plurality of mail messages, a social networking message list containing a plurality of messages between social networking users, a simple file storage system containing a plurality of files, or any other form of system or structure containing a plurality of messages. The plurality of messages is also not necessarily limited to those stored or transmitted to servers but may also be stored or transmitted to mobile devices, personal computers, and various other devices.

A message may be designated by any number of methods. For example, a message may be designated by flagging the message, categorizing the message, or marking the message as a favorite. As will be discussed in detail below, the message may further be designated via a function available through an Application Programming Interface (“API”). APIs are often available for popular services and websites that provide for the transmission of messages associated with a user. Examples include Google Talk, Twitter, and Facebook. In cases where a message has been sent to a particular Associated Profile, the designation of the message may take place automatically upon receipt.

Once a message is designated, a workflow is automatically initiated (step 104). For example, in an IT setting, a support ticket may be created representing the workflow. The workflow may be automatically populated with tasks that are necessary for the completion of the workflow. In the example set forth above, for a workflow requiring the installation of software, each of the steps to install software (i.e. initiate contact; arrange meeting; meet client; fix software; and receive feedback) may become a task. In addition, in certain embodiments of the present invention, the body of the message may be used as an input to the workflow. For example, the text portion of the message requesting the help, a picture or video contained in the message describing the issue, or even a recorded audio message may be automatically added (and transcribed where necessary) to the workflow. Alternatively, these transmitted messages may simply be associated with the workflow, for example, as files on a file system. In other embodiments, workflow details may be automatically generated based on the information detected in the designated message.

After a workflow is initiated, a message may be received within the workflow (step 108). In response, the message received in the workflow may be posted to the plurality of messages (step 112). Similarly, when a message is received that is related to an already initiated workflow (step 116), the received message may be automatically added to the initiated workflow (step 120). Hence, all messages that are related to the workflow may be tracked and automatically logged in the workflow as well as in the message system that was initially responsible for the creation of the workflow.

Embodiments of this invention may receive and analyze the information in each received message. This analysis may determine whether a message concerns a workflow already created, whether it concerns a separate issue, or whether it merits the creation of another workflow. To determine this, it may examine metadata information of the received message, the open workflows, and any previously programmed configurations or predetermined rules.

Continuing with the IT example, all messages communicated from the client may be automatically added to the workflow. Similarly, all messages communicated from the employees working on the issues associated with the workflow may be automatically added to the workflow or communicated back to the client that sent the message that initiated the workflow. As will be further discussed below in connection with the Automated Management Server, these messages may be accessible to the client at any time. The presently disclosed invention, further, may automatically notify the client when the status of the workflow changes or a task of the workflow has been completed.

Embodiments of the invention may also import information associated with one or more Associated Profiles into the workflow. Information may be imported using the Profile's username, password, and other information necessary to access the Profile and its associated data. The importing of this information, as will be further explained below, allows messages directed towards particular Associated Profiles to be tracked. Upon the receipt of a new message directed at an Associated Profile, a workflow may be automatically initiated. The importing of the Associated Profile information also allows communication with the message senders via this profile. Thus, the Associated Profile may then act as the contact point for any number of message senders. Embodiments of the presently disclosed invention may also import profile information of message senders, allowing the tracking of historical workflows associated with a particular client and the storing of client contact information. It may also allow the clients to connect to and manage information associated with their profile.

Certain embodiments of the invention may perform any number of conditional actions, each of which may be triggered by a predetermined event. Examples include: automatically replying to messages upon the creation of a workflow; automatically initiating contact with the user via telephone; automatically replying to frequently asked or simple questions; automatically initiating a predetermined procedure based on a received message; and automatically deleting any message that has been added to a workflow. These examples are not meant to be in any way limiting and any triggers or predetermined action is within the scope of the presently disclosed invention.

The workflow may also be managed with an account associated with the workflow, the plurality of messages, the message sender, or the message recipient, thereby allowing workflows to be created, edited, deleted, and otherwise managed. For example, using the associated account, a workflow may be updated when a task is completed, notes may be added relating to the workflow, additional tasks may be added, and the workflows may be completed and archived. As will be further explained below, workflow management may also occur automatically when a message is sent to or received from a clients without the need for any manual management within a workflow system.

### Automated Management Server and Network-Connected Devices

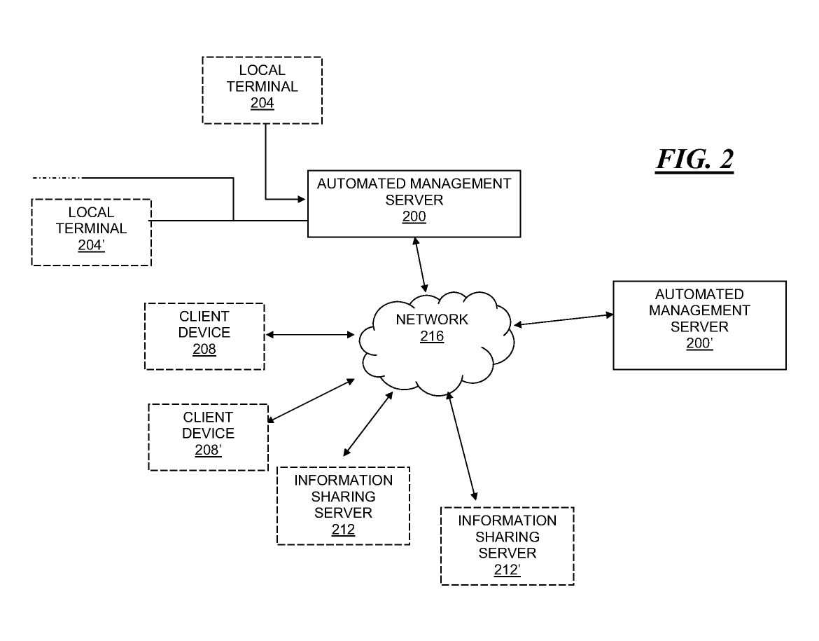

Referring to FIG. 2, an embodiment of the presently disclosed invention is depicted in the form of the Automated Management Server 200. The Automated Management Server 200 is connected to a Network 216, which allows it to further connect to a plurality of devices including other Automated Management Servers 200′, Client Devices 208, 208′, and Information Sharing Servers 212, 212′. Each of these devices may communicate with the other devices connected to the Network 216.

The Automated Management Server 200 of the presently disclosed invention allows for the automatic management of workflows, comprising at least a processor and memory coupled to the processor (neither shown). Some embodiments of the Automated Management Servers 200, 200′ further include a transceiver, allowing for the transmitting and receiving of data communications to and from Network 216. The memory of the Automated Management Server 200 comprises program instructions that, when executed by the processor, result in the designation of a message from a plurality of messages as discussed above and further detailed below. Upon the designation of the message from the plurality of messages, executed program instructions contained in the memory of Automated Management Server 100 cause the automatic initiation or creation of a workflow.

The Automated Management Server 200 may store the plurality of messages locally, such as on the same or different memory storage as the program instructions. It may track or access a plurality of messages that are stored remotely. For example, the plurality of messages may be stored remotely on Client Devices 208, 208′, Information Sharing Servers 212, 212′ or even another Automated Management Server 200′. Furthermore, the executed program instructions may store, track, or access multiple pluralities of messages that are stored at different locations.

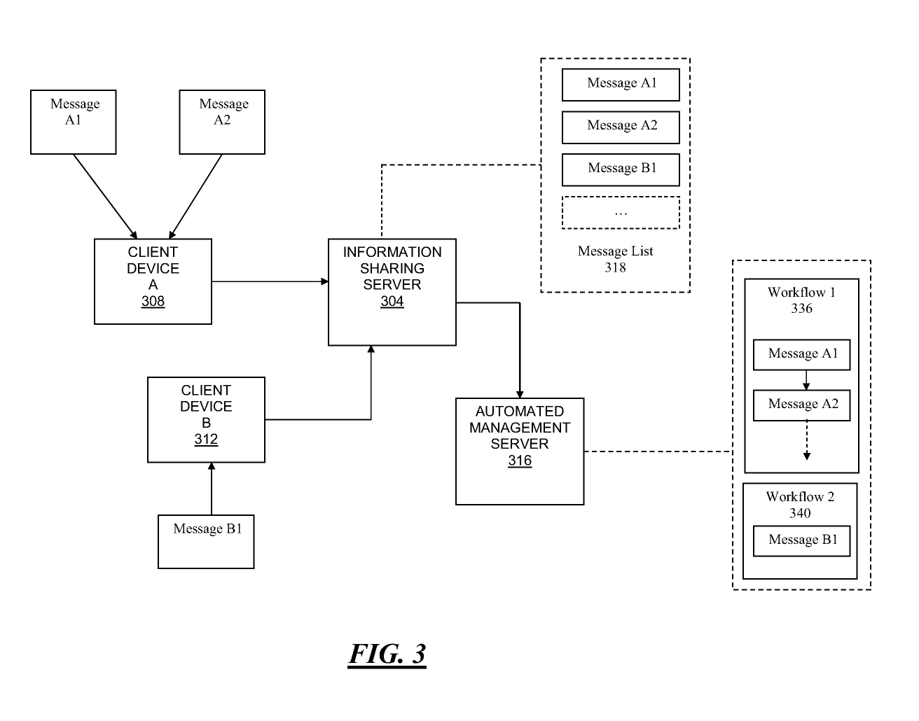

As will be further discussed in connection with FIG. 3, the Automated Management Server 200 has the capability to automatically create or initiate a workflow upon a user's designation of a message from a plurality of messages. Known methods of designating a message are well within the scope of the invention, including: flagging; marking as a favorite; placing into a particular folder; textual designation; graphical designation; downloading; or filtering.

When a workflow is created, it may be stored locally at the Automated Management Server 200 or, alternatively, it may be stored remotely and accessible via the Network 216. It should be appreciated that the memory of the Automated Management Servers 200, 200′ (and the memory of any other devices disclosed) may be any volatile memory or nonvolatile memory, or both. By way of illustration, and not limitation, a nonvolatile-memory may consist of read only memory (ROM), programmable ROM (PROM), electrically programmable ROM (EPROM), electrically, erasable programmable ROM (EEPROM), or flash memory. In the alternative or in addition, the memory may include volatile memory such as random access memory (RAM). RAM may take several forms, including static RAM (SRAM), dynamic RAM (DRAM), synchronous DRAM (SDRAM), double data rate SDRAM (DDR SDRAM), enhanced SDRAM (ES-DRAM), Synchlink DRAM (SLDRAM) and direct Rambus RAM (DRRAM) or other advanced forms of RAM known by one of ordinary skill in the art.

One of ordinary skill would understand that a chosen form of storage for the Automated Management Servers 200, 200′, such as a hard drive, need not be used exclusively for the Automated Management Server 200, 200′ but, rather, may contain other data, information, or programs related or unrelated to the operation of the present invention. It should be further appreciated that while the presently disclosed embodiment calls the Automated Management Server 200 a server, it may alternatively be embodied in a desktop computer, a personal computer, a laptop or any device containing a processor and memory.

One or more Local Terminals 204, 204′ may connect directly or indirectly, via a local area network, to the Automated Management Server 200. Local Terminals 204, 204′ may access the workflows via the Automated Management Server 200 to create, edit, delete, and otherwise manage the workflows. The Automated Management Server 200 allows a plurality of Local Terminals 204, 204′ to manage workflows concurrently in real time. In one embodiment, one Local Terminal 204 has the ability to make changes to workflows while the other Local Terminals 204′ may only view the workflows. This may ensure against accidental editing of the workflows. The use of a plurality of active Local Terminals to manage workflows is useful in sizeable organizations where information and projects continually change and progress. Continuing the example of an IT services organization, the use of Local Terminals 204, 204′ allows for a plurality of IT personnel to manage workflows concurrently.

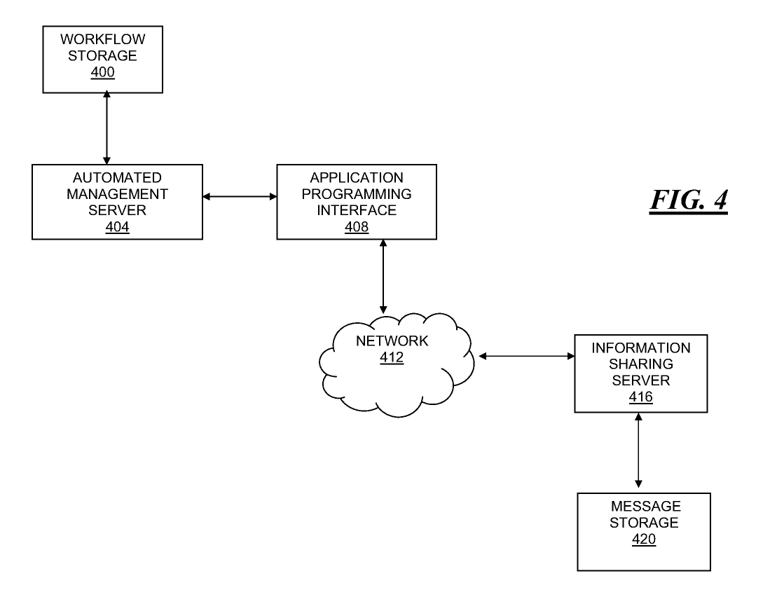

Client Devices 208, 208′ are also connected to Network 216, allowing the Devices 208, 208′ to communicate with other devices of Network 216 including the Automated Management Servers 200, 200′ and Information Sharing Servers 212, 212′. Client Devices 208, 208′ may be any device having a processor, memory and a transceiver, including personal computers and mobile devices. As further discussed in connection with FIGS. 2 and 4, through Client Devices 108, 108′, a user may access the plurality of messages available on network 116 and designate a message in one of the known methods, thereby causing the automatic initiation of the workflow by the Automated Management Server 200. The Client Devices 208, 208′ may also be used to remotely manage the workflows at the Automated Management Server 200.

Information Sharing Server 212 may contain at least one processor and memory. As with other devices connected to Network 216, the Information Sharing Servers 212, 212′ may each contain a network transceiver, allowing it to receive and transmit messages to a plurality of devices connected to the Network 216. The Information Sharing Server 212 may store in its memory a plurality of messages. However, this is not necessarily the case in all embodiments. Rather, the plurality of messages may be remotely located and the Information Sharing Server 212 may simply be used as a gateway or a point of access to the plurality of messages. In certain embodiments, each message may be related to at least one user profile or topic. This data may also be kept in the memory of the Information Sharing Servers 212, 212′.

In one embodiment, the Information Sharing Server 212 contains information relating to a plurality of user profiles and a plurality of topics. Each user profile and topic in the Information Sharing Server 212 may be associated with a plurality of messages. Further, in certain embodiments, each message in the plurality of messages may further contain associated metadata, containing information such as sender(s), receiver(s), time of transmission, time of receipt, related topic(s), etc. It may contain metadata that others may use and edit.

The Information Sharing Server 212 may receive numerous requests from Client Devices 208, 208′ and Automated Management Servers 200, 200′ for messages. The request may be confined to the plurality of messages associated with a particular profile or topic. The ISS 212 responds by transmitting the requested messages where the messages are available, or alternatively, denying or partially responding to the request based on message availability and any previously configured security or privacy rules. The Information Sharing Server 212 may have the capability to receive and respond to other types of requests beyond a request for messages as consistent with other features and embodiments of the present invention. Devices may access and download the files and messages contained in these servers 212, 212′ via any number of network protocols known within the art, including File Transfer Protocol, Hypertext Transfer Protocol, and Internet Message Access Protocol.

In certain embodiments, the Information Sharing Server 212 may store mailboxes each containing a plurality of email messages for any number of email recipients. In yet another embodiment, the Information Sharing Server 212 may simply be a file storage system, holding a plurality of files, each of which contains or represents a message. Another Information Sharing Server 212′ also connected to Network 216 may carry a different set of messages in its memory and may carry it in an entirely different format or structure.

In one embodiment, the Information Sharing Server 212 is a social networking server, storing a plurality of messages each associated with a social networking profile. For example, Twitter allows its users to post, send and receive text-based messages having up to 140 characters, each of which are stored on its servers. The messages sent and received are displayed instantaneously, with each user profile page displaying the messages posted by the user or associated with the user. Users may send messages to other users, which may also be displayed on the user's profile page. Thus, in one embodiment, a designated social networking message may automatically initiate a workflow.

In another embodiment, the Automated Management Server 200 includes all of the features and capabilities of the Information Sharing Server 212. In such a case, any communications described herein may nonetheless take place. However, such communication may not need to take place over a Network 216, but may take place entirely within the Automated Management Server 200. Information Sharing Servers 212, 212′ may nonetheless exist on Network 216, providing access to additional sources of messages.

Network 216 may be any network or collection of networks that carries data communications including communications from and to network capable devices. Network 216 may comprise, for example, a local area network, a wide area network, or a combination thereof. The Network 216 may carry communications from wired and wireless data devices, and may support a wide range of protocols and technologies, including those of the World-Wide Web. Embodiments of the present invention may additionally operate as a multi-protocol gateway among a plurality of messaging systems, thereby providing a single interface to several different kinds of information sources accessible by various, differing protocols. Thus, the devices shown in FIG. 2 may be able to communicate with each other on Network 216 even where the devices' network protocol systems differ.

### Workflow Creation

FIG. 3 demonstrates how workflows are automatically created, deleted, edited, and generally managed by the Automated Management Server 316. In the illustrated embodiment, the plurality of messages are stored at the Information Sharing Server 304. However, as previously discussed, Automated Management Server 316 may itself store the plurality of messages, thereby possibly foregoing the need for Information Sharing Servers 304 altogether.

FIG. 3 depicts an Information Sharing Server 304 connected to Client Device A 308, Client Device B 312 and Automated Management Server 316. While not shown, the devices and servers may be connected to each other via one or more networks. Client Device A 308 and Client Device B 312 may each send any number of messages to the Information Sharing Server 304. In this example, Client Device A 308 sends a message A1 and a message A2 to the Information Sharing Server 304. Similarly, a Client Device B 312 sends a message B1 to the Information Sharing Server 304. A message may contain text, pictures, video, audio or any combination thereof. Thus, a message sent from a Client Device may be a rudimentary text message or it may be a more complex message, involving files or data in Rich Text Format, Hyper Text Markup Language format, Portable Document F, Bitmap Image File format, JPEG format, Moving Picture Experts Group format, Audio Video Interleave format, or other known text, picture, video, and audio formats. Thus, continuing the IT support example, users who are having trouble with their computers may send a message to the Information Sharing Server 304 using a Client Device.

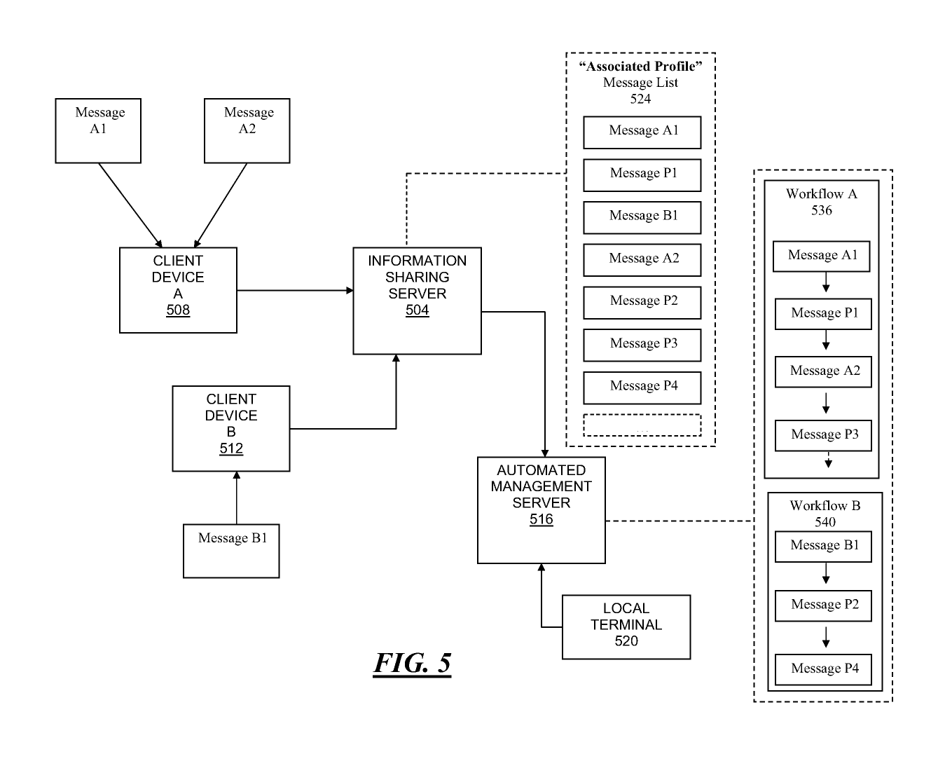

At the Information Sharing Server 304, each message is automatically added to a Message List 318. This message list may contain all messages sent to the Server 304, or the messages may be divided among multiple message lists. The Information Sharing Server 304 further has the capability to automatically detect and group messages into predetermined categories. The Information Sharing Server 304, for example, may detect that a message concerns the need for help in installing software and may group all such messages together by their subject. The Information Sharing Server 304 may also have the capability to detect that the message is directed toward a particular person and group these directed messages by their recipient. This particular feature will be explained in further detail with regard to the Associated Profile in connection with FIG. 5. As each message is processed by the Information Sharing Server 304, the messages directed to an Associated Profile related to the Automated Management Server 316 are provided to the Automated Management Server 316.

Upon the designation of a particular message, such as by marking the message as a favorite, the Automated Management Server 316 automatically initiates a workflow at the Automated Management Server 316. The designation may take place at the Automated Management Server 316, Information Sharing Server 304, or at any devices connected to the Information Sharing Server 304 via a network. Upon the designation of a message by any of these methods, a signal may be sent to the Information Sharing Server 304, notifying it of the designation of that particular message. Information Sharing Server 304, in response, updates its records to reflect the designation of the message.

The designation of the message is conveyed to the Automated Management Server 316. This may be done by downloading updated messages status data from the Information Sharing Server 304 as individual messages are received or modified, examining the downloaded data, and creating the workflow in response to the designation of the message. In embodiments where message designation data is not kept at the Information Sharing Server 304 and is instead kept at the Automated Management Server 316, notification of a message's designation is sent to the Automated Management Server 316. In these embodiments, the change in message status is detected at the Automated Management Server 316 and the workflow is initiated. In addition, in certain embodiments, where a private message is received at the Information Sharing Server 304, the workflow may automatically be initiated without any designation of the message by a person.

The Automated Management Server 316 may automatically use the body of the received message as part of its workflow. It may further detect whether a message is related to a previously created workflow. For example, the Automated Management Server 316 may examine the contents or metadata of a message received at the Information Sharing Server 304. Using this information, the Automated Management Server 316 will be able to determine that a new workflow should be initiated or, on the other hand, that the message needs to be added to a previously initiated workflow. It may for example, examine the message for particular keywords or key phrases. Automated Management Server 316 may also contain program instructions that may algorithmically determine whether a new workflow needs to be created. These algorithms may consider a plurality of factors and previously-stored information.

In the example depicted in FIG. 3, the Automated Management Server 316 automatically created Workflow A 336 and Workflow B 340 upon the designations of message A1 and Message B1 by the users of Client Device A 308 and Client Device B 312 after algorithmically determining that the attributes of Message A1 and Message B1 are distinct. On the other hand, it may determine that Message A2 is related to Workflow A 336, partly because it originates from the same user and shares other similarities.

### Application Programming Interface

Messages stored on the Information Sharing Server may be stored in any number of ways. The server is not necessarily restricted to a particular software or computing infrastructure, but instead may operate using any known hardware or software architecture. In order to ensure that the Automated Management Server may communicate with the Information Sharing Server, embodiments of the presently disclosed invention typically utilize an Application Programming Interface (“API”), a technique well known in the art for allowing access to data stored at a third party server. APIs can also allow for the execution of functions and processes at that third party server. APIs, for example, are available for e-mail and social networking services such as Facebook, Google Talk, and Twitter.

As seen in FIG. 4, API 408 acts as a communication bridge between Automated Management Server 404 and Information Sharing Server 416, allowing Automated Management Server 404 to access and use the data contained in the Information Sharing Server's message storage 420, regardless of how the data is structured or where the data is located within the storage 420. The API further allows the Automated Management Server 404 to readily detect when a message has been designated. In certain embodiments, the use of APIs allow the Automated Management Server 404 to access and analyze the metadata of each message to determine the designation status of the message. In addition, APIs may further allow the Automated Management Server 404 to call functions and direct the Information Sharing Server 416 to perform a particular act, such as designating a message or retrieving all messages related to a particular topic or user.

### Workflow Management

With reference to FIG. 5, the Automated Management Server 516 further contains program instructions that, when executed, allows for the automatic creation of workflows based on messages received and directed at an associated profile hosted at the Information Sharing Server 504. Embodiments of the invention further allow a Local Terminal 520, as exemplarily depicted in FIG. 5, to configure the Automated Management Server 516 and manage the workflows.

Similar to FIG. 3, FIG. 5 depicts an Information Sharing Server 504 connected to Client Device A 508 and Client Device B 512 as well as Automated Management Server 516. The Information Sharing Server 504 may have the capability to store messages associated with user profiles, including in this example, a profile named “Associated Profile.”

The Automated Management Server 516 may further be configured to import information associated with a user profile hosted at the Information Sharing Server 504, i.e. an Associated Profile. For example, the Automated Management Server 516 may be supplied with a username, password, and any other information necessary to access the profile and its associated data at the Information Sharing Server 504. By importing the Associated Profile information, the Automated Management Server 516 may then be configured, via an API or other known methods, to automatically download all messages directed at the associated profile as they are received at the Information Sharing Server 404.

Once the Automated Management Server 516 is configured, an organization then may direct all of its clients to send messages to the Associated Profile, allowing for the creation and management of workflows using these messages. The Automated Management Server 516 may import information associated with multiple Associated Profiles, allowing for the creation and management of different workflows using messages to be sent to different profiles at the Information Sharing Server 504. For example, messages concerning networking issues may be sent to one profile while messages concerning software issues may be sent to a different profile.

Client Device A 508 and Client Device B 512 may each send any number of messages to the Information Sharing Server 504. As seen in FIG. 5, Client Device A 508 sends a message Al to the Information Sharing Server 504, directed to the Associated Profile. It is received by the Information Sharing Server 504 and posted on Associated Profile's message list. An employee of the organization, either via Local Terminal or via a remote device, may notice the first received message A1. The employee may determine that it is a relevant message. The employee may then designate the message. The Automated Management Server 516, having been previously configured to receive messages from the imported profile information of the Associated Profile, may detect that message A1 has been designated. In response to the detection, the Automated Management Server 516 may automatically initiate workflow A 536 and create one or more tasks related to the message A1.

The Automated Management Server 516 may also have the capability to import information associated with the client's profile from the Information Sharing Server 504. Thus, the Automated Management Server's memory would further hold a database of profile names and associated information for its clients, in this case, the users operating Client Device A 508 and Client Device B 512. This may allow the Automated Management Server 516 to track the history of workflows associated with each client and may allow employees to contact the client through contact information associated with the profile. It would also allow clients to connect to and manage information associated with their profile stored at the Automated Management Server 516.

The Automated Management Server 516 may be further configured to automatically act in a plurality of predetermined manners upon the satisfaction of predetermined conditions. For example, it may be configured to automatically reply to Message A1 by posting its own message P1 on the message list of the Associated Profile or on the message list associated with the sender of Message A1. Thus, in FIG. 5, the Automated Management Server 516 automatically replies to the initial message A1 sent by a client by posting a message P1 in the Associated Profile message list 524. The message may, for example, confirm the receipt of the message and confirm the creation of a support ticket to address the client's needs. The Automated Management Server 516, similarly, sends out another message P2 upon its receipt and designation of Message B1 from Client Device B 512. In other embodiments, the Automated Management Server 516 may be configured to automatically email, telephone, or notify a particular person or group.

The Automated Management Server 516 also may be configured to automatically initiate a process. For example, upon receiving a designated message that a particular server is malfunctioning, the Automated Management Server 516 may automatically restart or shut down the server. Any number of actions may be taken and may be configured by a local or remote terminal connected to the Automated Management Server 516. The Automated Management Server 516 may also be configured to automatically reply and answer frequently asked or simple questions with predetermined answers such as, for example, a question asking about the IT department's business hours or the status of a particular support ticket. In certain embodiments, the Automated Management Server 516 may learn from employee answers to questions having certain keywords and may automatically answer the question in the future. In other embodiments, the Automated Management Server 516 may be configured to automatically delete any message at the Information Sharing Server 504 that has been added to the workflow.

Upon the receipt of a second Message A2 from Client Device A 508, for example, the Automated Management Server 516, determining that the message is related to the Message A1, automatically adds it to the Workflow A 536. Such messages may provide supplemental information regarding the client's issue to assist the individual processing the workflow.

The Automated Management Server 516 also allows for the management of workflows. This may be possible through the Automated Management Server 516 or the Information Sharing Server 504. An employee may log into the Automated Management Server 516, either through a Local Terminal 520 or a remote device, to manage workflows. In addition to the configuration options previously discussed, an employee may further create, modify, or delete workflows, client lists, and predetermined answers to frequently asked questions. An employee, for example, may have received a phone call from the client with regard to Workflow A 536. In response, the employee may create a note concerning the phone call in the workflow. The employee may also post a message to the Message List confirming the call. In addition, the Automated Management Server 516 further allows for the completion of workflows. An employee, after addressing the client's issues, may close the workflow and mark it as complete. The workflow may then be archived or deleted.

1. The Automated Management Server 516 may also be configured to automatically manage the workflow based on actions occurring at the Information Sharing Server 504. Through the use of one or more imported Associated Profiles, the Automated Management Server 516 may track the messages communicated between the client and the employees. The Automated Management Server 516 may further examine each message for functional keywords. For example, the Automated Management Server 516 may detect words that indicate the status of the workflow (e.g., “Closed,” “In progress”); a particular solution to a question (e.g., “restart the computer”); or requests for contact information (e.g., requests for email or phone numbers). In response, the Automated Management Server 516 may automatically add additional tasks to the workflow, update the status of the workflow, log any relevant information, configure the server to auto-reply to frequently asked questions, and track any later received messages and act accordingly. Thus, by using the imported Associated Profile information, the Automated Management Server 516 allows employees to manage the workflow via the Information Sharing Server 504, without having the need to log into the Automated Management Server 516. Rather, they may simply reply to messages received. The management of the workflows is automated by the disclosed invention.

It will therefore be seen that the foregoing represents a highly advantageous approach for workflow management. The terms and expressions employed herein are used as terms of description and not of limitation and there is no intention, in the use of such terms and expressions, of excluding any equivalents of the features shown and described or portions thereof, but it is recognized that various modifications are possible within the scope of the invention claimed.

What is claimed is:

1. A method for the automated management of a workflow, the method comprising:
designating a message from a plurality of messages; and
automatically initiating a workflow in response to the designating of a message.

2. The method of claim 1, wherein designating a message comprises designating the message as a favorite using a publicly-available API.

3. The method of claim 1, further comprising utilizing the contents of the designated message as an input to the workflow.

4. The method of claim 1, wherein the workflow is a support ticket.

5. The method of claim 1, further comprising receiving a message within the workflow and posting it to the plurality of messages.

6. The method of claim 1, further comprising
receiving a message related to the initiated workflow; and
adding the received message to the workflow in response to the receiving of the message.

7. The method of claim 1, further comprising importing social profile information into the workflow.

8. The method of claim 7, further comprising specifying conditional actions triggered by the imported social profile information.

9. The method of claim 1, further comprising performing conditional actions triggered by a predetermined event.

10. The method of claim 1, further comprising managing the workflow with an account associated with the plurality of messages.

11. A device for the automated management of a workflow, the device comprising: a processor, and a memory coupled to the processor wherein the memory comprises:
program instructions that when executed by the processor result in the designation of a message from a plurality of messages; and
program instructions that when executed by the processor result in the initiation of a workflow in response to the designating of a message.

12. The device of claim 11, wherein the program instructions to designate a message comprise program instructions to designate the message as a favorite using a publicly-available API.

13. The device of claim 11, wherein the memory further comprises program instructions that when executed by the processor result in the programmatic usage of the contents of the designated message as input to the workflow.

14. The device of claim 11, wherein the workflow is a support ticket.

15. The device of claim 11, wherein the memory further comprises program instructions that when executed by the processor result in the programmatic receipt of a message within the workflow and posting that received message to the plurality of messages.

16. The device of claim 11, wherein the memory further comprises program instructions that when executed by the processor result in the programmatic
receipt of a message related to the initiated workflow; and
adding the received message to the workflow in response to the receipt of the message.

17. The device of claim 11, wherein the memory further comprises program instructions that when executed by the processor result in the programmatic import of social profile information into the workflow.

18. The device of claim 17, wherein the memory further comprises program instructions that when executed by the processor result in the programmatic specification of conditional actions triggered by the imported social profile information.

19. The device of claim 11, wherein the memory further comprises program instructions that when executed by the processor result in the programmatic performance of conditional actions triggered by a predetermined event.

20. The device of claim 11, wherein the memory further comprises program instructions that when executed by the processor result in the programmatic management of the workflow with an account associated with the plurality of messages.
